(19) United States
(12) Patent Application Publication
(10) Pub. No.: US 2013/0032162 A1
(43) Pub. Date: Feb. 7, 2013

(54) CUSTOMIZABLE WIG WITH ENHANCEMENT FEATURES AND BOX FOR SAME

(71) Applicant: Tré MAJOR, Beverly Hills, CA (US)

(72) Inventor: Tré MAJOR, Beverly Hills, CA (US)

(21) Appl. No.: 13/565,776

(22) Filed: Aug. 2, 2012

Related U.S. Application Data
(60) Provisional application No. 61/514,368, filed on Aug. 2, 2011.

(51) Int. Cl. A41G 3/00; G09B 19/00; A41G 5/00

(52) U.S. Cl. 132/54; 434/94

(57) ABSTRACT

A customizable wig can be reversibly altered to create a wide variety of hairstyles. A customizable wig comprises a single base shell having an outer surface, a plurality of fasteners affixed to its outer surface, and a plurality of hair segments that can be fastened to the shell. The hair segments comprise at least one crown segment, at least one mid-section segment, and at least one nape segment. The segments can be removably attached by a variety of fasteners such as hook and loop fasteners or snaps. In order to provide even more options for alternative hairstyles, the crown, mid-section, and nape segments can comprise more than one segment. Enhancements such as feathers, hair wefts, or beaded strings can be easily attached to create additional styles. A box is optimized for protection during storage and transport, as well as for display of the wig.

The present application claims benefit of provisional patent application 61/514,368, filed on Aug. 2, 2011, the entire contents of which are incorporated herein by reference.

### BACKGROUND

Men and women wear wigs for a variety of reasons. Some individuals wear wigs to mask hair loss due to pattern baldness caused by aging, alopecia, or chemotherapy treatment. Others wear wigs as a head covering for religious reasons. Still others find their hair unmanageable or difficult to style in the way they like and find wigs an attractive alternative.

Wigs can be custom-made for a completely unique wig style, but this process often takes several weeks to several months. Custom wigs contain tens of thousands of strands that must be hand-tied to the wig by the wig-maker. Off-the-shelf wigs are available in the marketplace, but these wigs are not customized for the wearer and may not be available in the style a wearer chooses. Many individuals enjoy styling their hair differently for different occasions. For example, a straight, cropped look may be suitable for work while a curly style or an up-do is more appropriate for a special occasion or a night out. A wig owner could purchase multiple wigs in different styles, but this is expensive and still fairly limited in the number of styles possible. Attempts have been made to design wigs that can allow for simple changes in style. U.S. Pat. No. 3,495,603 and published US Patent Application US2010/0326455 A1 describe a wig with a detachable top hairpiece. U.S. Pat. No. 4,658,841 describes a wig with a front piece and a back piece that can be swapped to create a few different styles. Published US Patent Application US2008/0264435 A1 describes a wig with interchangeable, detachable auxiliary portions in two lengths to create two different looks.

The above-described wigs allow for only very limited style changes. There remains a need for a customizable wig that can be changed with ease to create a variety of different hairstyles without requiring purchase of an expensive new wig or waiting for a custom wig to be crafted.

### SUMMARY

The present invention is directed to a customizable wig that satisfies the need for a wig that can be altered to create a wide variety of hairstyles. In one embodiment, the customizable wig comprises a single base shell having an inner surface and an outer surface. The inner surface faces the wearer's head when the wig is being worn. The wig further comprises a plurality of fasteners affixed to the outer surface, and a plurality of hair segments that can be removably fastened to the shell. The hair segments comprise at least one crown segment, at least one mid-section segment, and at least one nape segment. In a typical embodiment, each of said hair segments comprises a base material having lower and upper surfaces, fastening means affixed to the lower surface of said base material, and a plurality of hair strands affixed to and extending from the upper surface of said base material. Typically, each of said hair segments is removably attached to the outer surface of said base shell by said fastening means. The hair segments can be removably attached by a variety of fasteners, such as hook and loop fasteners (VELCRO®), or snaps. In order to provide even more options for alternative hairstyles, the crown, mid-section, and nape segments can comprise more than one segment.

The hair strands affixed to the segments can be either human hair strands or synthetic hair strands. The hair strands can be affixed to the base material of the segments using any of a variety of conventional means known to those skilled in the art. Although the hair strands can be attached in a variety of ways that may involve either or both the upper and lower surfaces of the segment, for the purposes of this invention, the hair strands are said to be affixed to the upper surface of the base material in that they are positioned to extend from the upper surface. Thus, however the hair strands might be attached to the base material, they are affixed in such a way that the length of the hair strands are visible on the outside of the wig when worn by a wearer.

Optional hairline looks can be achieved by having, for example, at least one crown segment with an edge aligning with the wearer's forehead and having a sheer lace, or a trim piece forming a neat edge along the hairline, affixed to the front edge. Additionally, enhancements such as hair wefts, feathers, and beads can be removably attached to the cap or shell by fasteners. The customizable wig of the present invention permits hair segments to be varied in texture, color or length to create dramatic changes in the wig hairstyle. Enhancements can also be included easily by fastening them directly to the base cap. This flexibility enables a person to purchase a single wig for a given look and to purchase additional hair segments or enhancements to dramatically change their look with little time and effort. Alterations to the hairstyle can be made without necessitating removal of the entire wig.

The invention also provides a box optimized for protection during storage and transport, as well as for display of the wig. The box comprises a transparent window through which a wig placed inside the box is visible when the box is closed, and opens from one side via a panel and top connected to the bottom of the box by hinge means and having tabs that can be inserted inside the sides and top of the box. A handle secured in and protruding from a fixed top panel passes through the inserted moveable top panel to secure the box when closed and to provide ease of transport.

These and other features, aspects, and advantages of the present invention will become better understood with reference to the following description, appended claims, and accompanying drawings where:

### BRIEF DESCRIPTION OF DRAWINGS

FIG. 1 is an expanded view of a customizable wig embodying features of the present invention.

FIG. 2 is a planar view of three hair segments, shown here without the hair, of an embodiment of the present invention.

FIG. 3 is a perspective view of another embodiment of the customizable wig of FIG. 1 having a lace edge.

FIGS. 4A-4C are views of three enhancements for the customizable wig of FIG. 1.

FIG. 5A is an expanded view of another embodiment of the customizable wig of the present invention in which the hair segments attach directly to each other. For illustrative purposes, the segments are depicted without the hair that would extend from these segments.

FIG. 5B is a view of the hair segments of FIG. 5A attached together to form the shape of a human scalp.

FIGS. 6A-6B are digital photographic images of a wig of the invention depicting two variations of the crown segment, FIG. 6A with longer hair in the crown segment and FIG. 6B with bangs in the crown segment.

FIGS. 7A-7B are digital photographic images of an angled side view of a box of the invention in a partially (7A) and full (7B) opened position, showing an example of an optional label on a side panel, a model head supporting a wig placed within the box, a handle protruding from the fixed panel of the top, and the four insertable flaps extending from the sides of the front and moveable top panels.

FIGS. 7C-7E are digital photographic images of the box as viewed from the front while in a closed position, with a model head visible through the window in the front panel.

FIG. 7F is a digital photographic image of the back of the box, with an optional label affixed thereto.

FIG. 7G is a digital photographic image of the bottom of the box.

FIG. 7H is a digital photographic image of a side of the box while in a partially opened position, with an optional label affixed thereto.

FIG. 7I is a digital photographic image of the back of the box while in a partially opened position, with an optional label affixed thereto.

FIG. 7J is a digital photographic image of a front view of the inside of the box while in a completely opened position.

FIG. 7K is a digital photographic image of a front view of the inside of the box while in a completely closed position, and with the optional insert shown outside of and next to the box.

FIG. 7L is a digital photographic image of a front view of the inside of the box while in a completely opened position, and with the optional insert shown inside of the box.

FIG. 7M illustrates a top view of the box in the closed position.

FIG. 7N illustrates a side view of the box in the closed position, the other side being a mirror image of this side.

### DEFINITIONS

The term “hair segment” as used in this application means a plurality of hair strands attached to a breathable base material. The breathable base material can be similar or identical to that used for a base shell. When shapes of hair segments are described in this application it is the base material shape that is being described. The hair strands fall from the base material as natural hair falls from a scalp.

The term “base shell” as used herein refers to a wig cap or wig base similar to what is commonly used in the art to serve as the base for a wig and to which wig hairs would otherwise be attached. In the context of the present invention, however, the base shell typically does not have hairs attached to it. Instead, hairs are attached to the hair segments, which in turn are removably attached to the base shell or cap. A base shell is typically made of lace, netting, or other breathable material of either synthetic or natural origin, such as, for example, nylon or silk.

The term “crown” in this application means a section of the scalp on the top of a head horizontally bounded by the outer corners of the eyes and extending around the edge of the flat portion of the head.

The term “midsection” as used in this application means the portion of the scalp between the crown and the tops of the ears.

The term “nape” as used in this application means the portion of the scalp between the tops of the ears and the hairline along the neck.

The above-described borders are generalizations. It is understood by one skilled in the art that variations in these borders can be tolerated while still providing segments that can be used together to form a complete and wearable wig.

As used herein, “enhancements” refers to decorative items that can be attached to the wig and incorporated into the hairstyle. Examples of decorative items include, but are not limited to, hair wefts, feathers, and beads. Enhancements optionally include a fastening means affixed to an end of the decorative item so the enhancements can be removably attached to the cap, base shell and/or hair segments, by use of said fasteners.

The term “weft” as used in this application means a hair extension, such as a row of hair that falls from a support piece having elongated and flexible dimensions similar to those of a shoestring. Typically, the weft comprises a fastening means at either end and, optionally along its length, to facilitate removable attachment to the wig via a fastening means on the outer surface of the base shell or the upper surface of a hair segment.

The term “perimeter edges” as used in the application means the edges of a wig that align with the wearer's hairline. In some embodiments, the perimeter edges align even with the natural hairline, while in other embodiments, the perimeter edge, or a portion of the perimeter edge (e.g., that along the forehead, or that along the nape) is just short of, or just beyond the natural hairline, yet generally follows the contours of the hairline.

The term “joining edges” as used in this application means the edges of hair segments that align with other hair segments and do not align with the wearer's hairline.

### DESCRIPTION

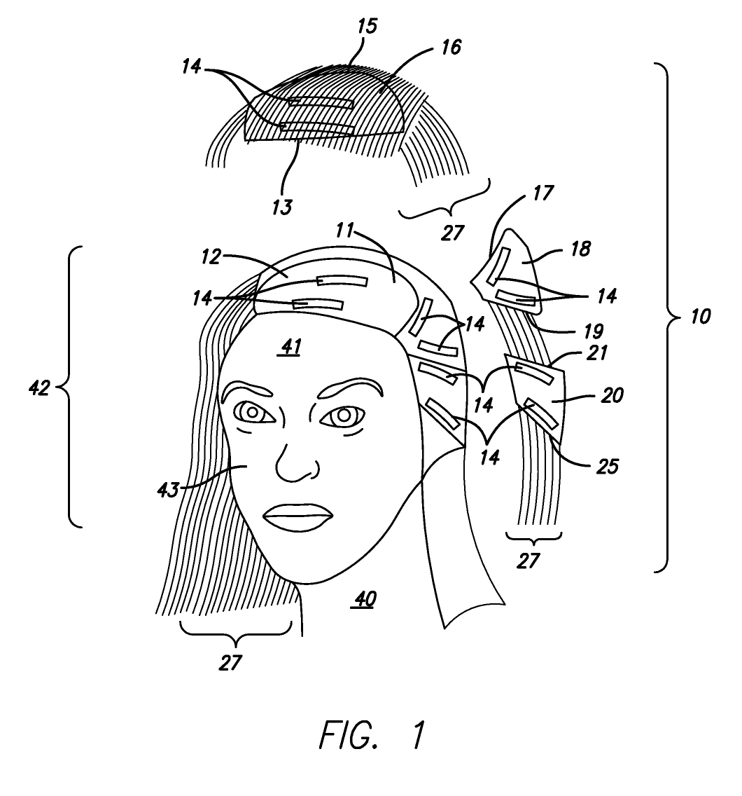

As shown in FIG. 1, a customizable wig 10 comprises a single base shell 12 having an outer surface 11 and a plurality of fastening means 14 affixed to the outer surface 11 of the shell 12, and at least one crown hair segment 16, at least one mid-section hair segment 18, and at least one nape hair segment 20, each segment of which (16, 18, 20) can be removably attached to the base shell 12 via the fastening means 14. The shell 12 can be sized to fit the wearer 40. The fastening means 14 includes, but is not limited to, fasteners such as hook and loop fasteners, snaps, hooks, or clips. The crown hair segment 16 sits on top of the head 42 of the wearer 40 and has a front edge 13 lining the forehead 41 of the wearer 43 and a curved back edge 15 extending from a point on the forehead 41 of the wearer 40 just above the outer corner of one eye 43 to just above the outer corner of the other eye thereby forming a “D” shaped segment. The mid-section hair segment 18 comprises a first long edge 17 having a length similar to that of the curved back edge 15 of the crown hair segment 16 and a second longer curved edge 19 that meets the first long edge 17 to form an approximately crescent-shaped mid-section hair segment 18. The nape hair segment 20 has a first long edge 21 that is similar in length to the second longer curved edge 19 of the mid-section hair segment 18 and a second longer curved edge 25 that meets the first long edge 21 to form a second approximately crescent-shaped nape hair segment 20.

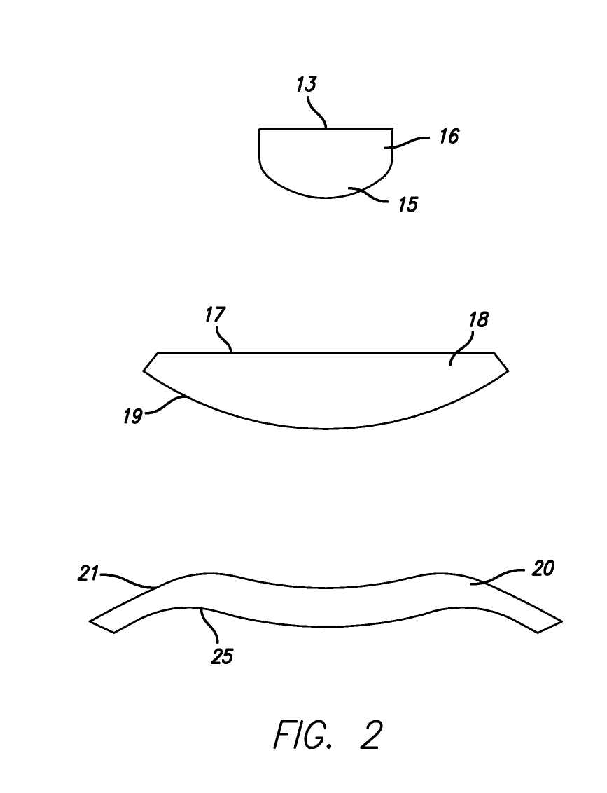

FIG. 2 shows a planar view of the hair segments 12, 18, and 20. The hair strands 27 of the hair segments 16, 18, and 20 can be of various grades of human hair (representative examples including Indian Remy, European, Italian, Russian, Chinese), synthetic hair, or a mix of human and synthetic hair of various colors and textures (curly, wavy, straight, light, medium, and dark).

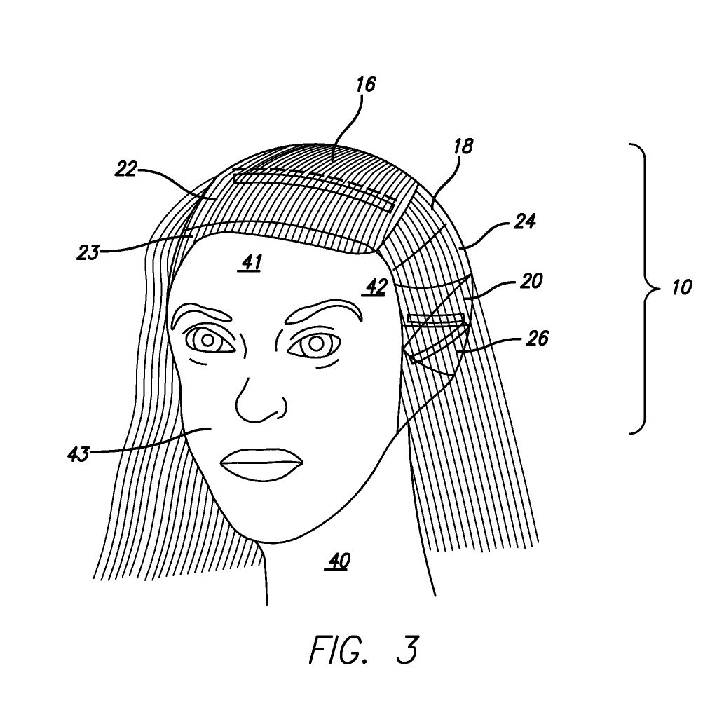

As shown in FIG. 3, another embodiment of the present invention comprises at least two crown hair segments 16 and 22 wherein the front crown hair segment 22 aligning with the wearer's forehead 41 optionally has a sheer lace edge 23. The sheer lace edge 23 is nearly invisible against the wearer's skin and allows the wearer 40 to wear hair styles with hair pulled back from the hairline. Additional embodiments of the invention comprise at least two mid-section hair segments 18 and 24, and at least two nape hair segments 20 and 26.

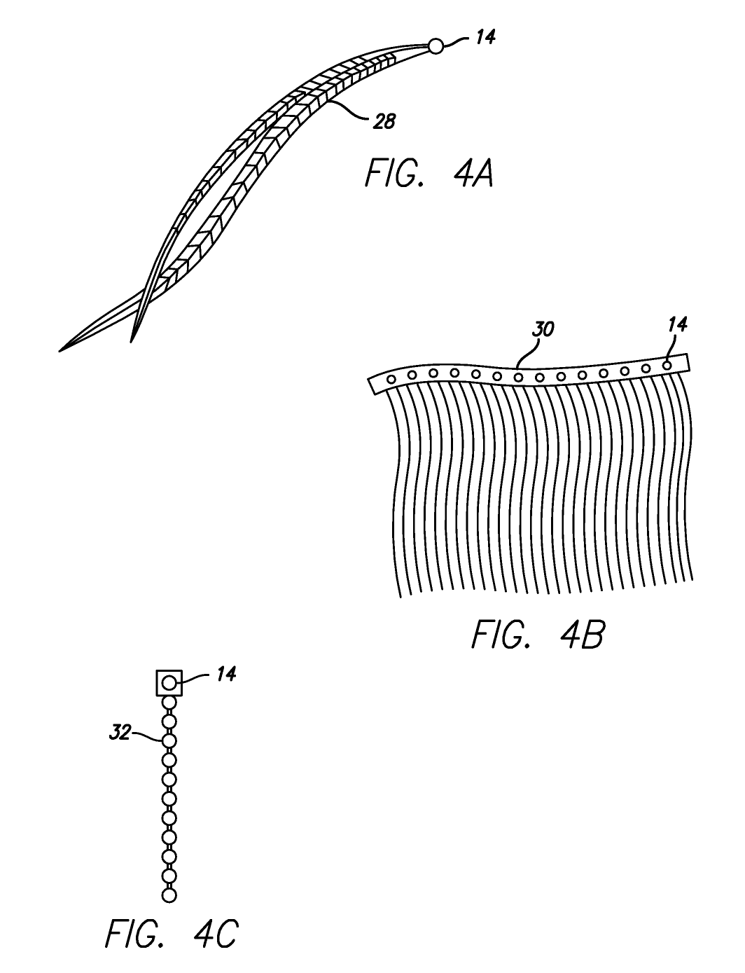

As shown in FIGS. 4A-4C, several enhancement features (feathers 28, hair wefts 30, and beaded string 32) can be affixed to the customized wig 10 of FIG. 1 by fastening means 14.

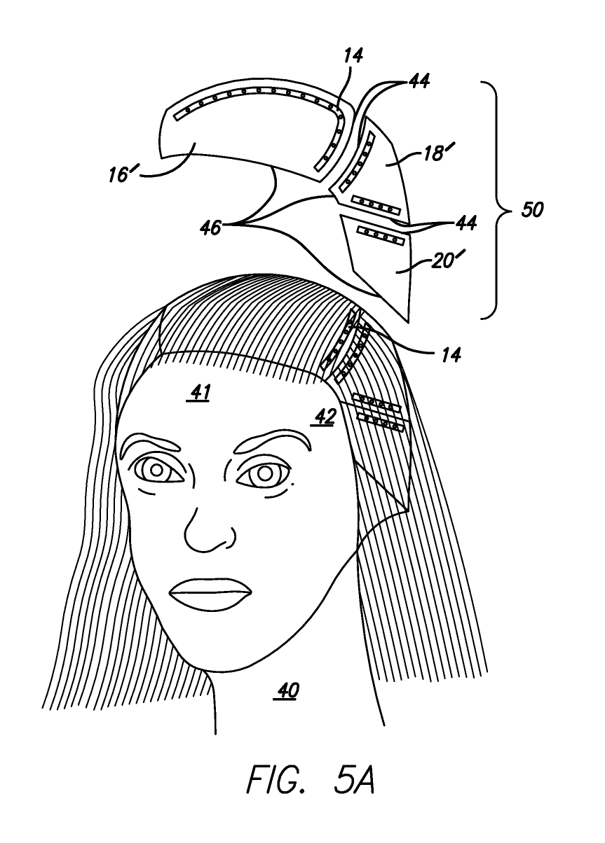

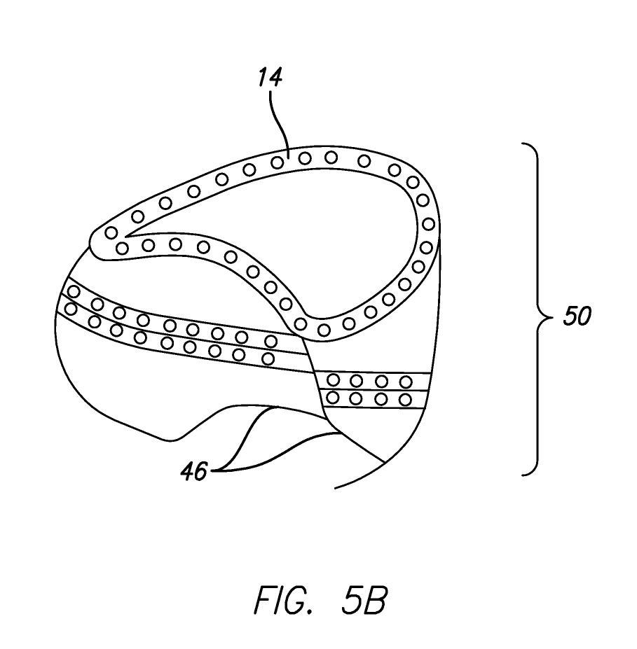

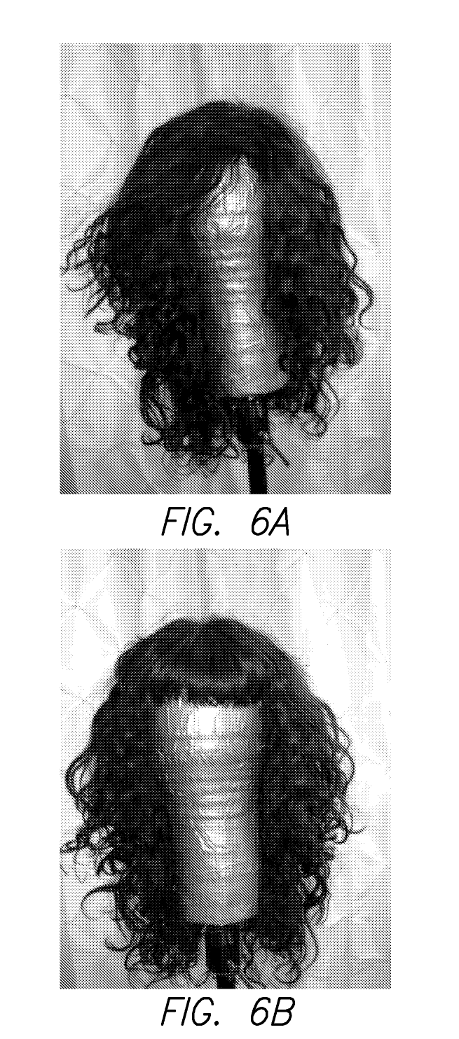

As shown in FIG. 5, another embodiment of the present invention comprises one or more hair segments 16′,18′, and 20′ that attach directly to each other rather than to a single base. Each hair segment has fastening means 14 lining joining edges 44. Perimeter edges 46 of the segments 16′,18′, and 20′ are free of fastening means.

Another embodiment of the present invention comprises a customizable wig kit. The wig kit comprises the elements of the customizable wig of FIG. 1 in addition to a set of instructions for assembling and arranging the hair segments into a variety of styles. The instructions can be provided in paper and/or electronic form, and can include both text and images, such as diagrams and/or photographs. The wig kit optionally includes an instructional video, such as a

DVD or other computer-readable medium, to demonstrate styling options. The video can demonstrate methods of styling hair, which methods are additionally provided by the invention.

The methods comprise attaching one or more hair segments as described herein to other hair segments or to the base shell of the invention. The method optionally includes removing one or more hair segments and/or enhancements, and replacing them with a different hair segment and/or enhancement, to achieve a different look.

The previously described embodiments of the present invention can enable a person to purchase a single wig with the flexibility to create different hairstyles by adding additional hair segments or enhancements to dramatically change the look with little time and effort. A wearer could make the alterations to the wig at home, or could alternatively take their wig to a hair stylist for more complex or professionally enhanced styling options. The wig of the present invention satisfies the need for a wig that can be altered to create a wide variety of hairstyles. Wig wearers do not need to wait the several weeks for a custom wig to be manufactured and shipped. In addition, the user can change their style on a whim or to suit a special occasion, or to change from a professional-looking style for work to a more glamorous style for evening. These changes can be made without having to remove the entire wig. The wearer can invest in a single wig base and then purchase additional hair segments and enhancements as desired at a later time. Additionally, the wearer can experiment with more dramatic styles without investing in the cost of a full custom wig.

A larger number of hair segments allows for more complicated hair styles. For example, one can create a layered hairstyle by employing a lace hairline as a crown segment, plus segments having short, medium, long and longer hair, providing multiple layers with varying lengths of hair. This embodiment can be used to achieve a look with a lot of volume and a realistic hairline using five segments. The sheer lace edge is used to provide a realistic-looking hairline. In another example, one can achieve a tri-level bob with a tapered nape by using five segments. The shape of the bob can be adjusted by selecting the hair lengths for the five segments to add more dimension, style, edge and volume, as desired.

The invention further provides a box for transporting, protecting and displaying a wig. The box comprises a front panel having a window disposed therein, a bottom, a rear panel, two side panels, a two-part top panel, and four insertable flaps. A five-sided structure is formed by the a fixed top panel, bottom, two side panels and the rear panel due to rigid (non-moveable) connections between these five sides. The front panel is connected to the bottom by a hinge. All references to a hinge in the context of the box refers to any form of moveable connection between two panels. A hinge of the box typically comprises a crease or fold in a continuous piece of material, such as cardboard. Logos and package labels are optionally adhered to or displayed on the side and/or rear panels, and can also be displayed on the front, top and bottom.

The top panel comprises two panels. One panel of the top is a fixed panel that is contiguous (either through a bend in a continuous sheet of material, or by secured attachment via flaps or other attachment means) with the rear and side panels and has a handle secured therein, preferably in the center of the fixed panel. Secured attachment can be achieved via adhesive material (e.g., glue), staples, rivets, and other conventional means known in the art. The two-part top panel further comprises a moveable panel that is contiguous with the front panel and comprises an opening through which the handle passes. When the box is in a closed position, the fixed and moveable panels of the top panel are aligned, with the handle protruding through the opening in the moveable panel, allowing one to carry the box by the handle with the box secured in the closed position.

The insertable flaps are contiguous with either side of the front panel and the moveable top panel, for a total of four flaps. The flaps insert inside of the five-sided structure formed by the fixed top panel, bottom, two side panels and the rear panel. Thus the complete box is formed by one contiguous piece of material, the window disposed within the front panel, and the handle disposed within the fixed top panel.

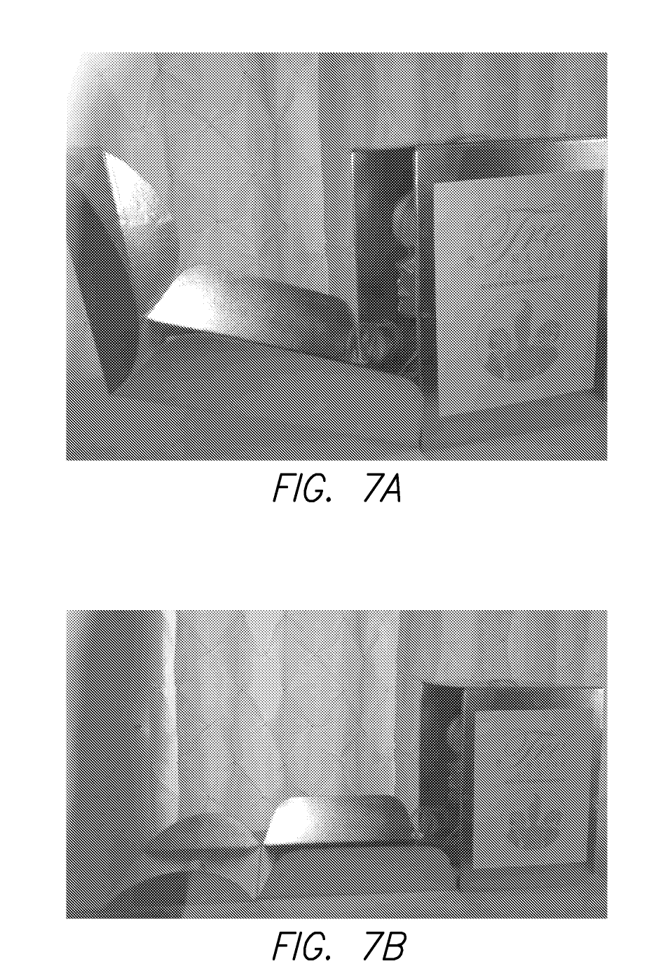

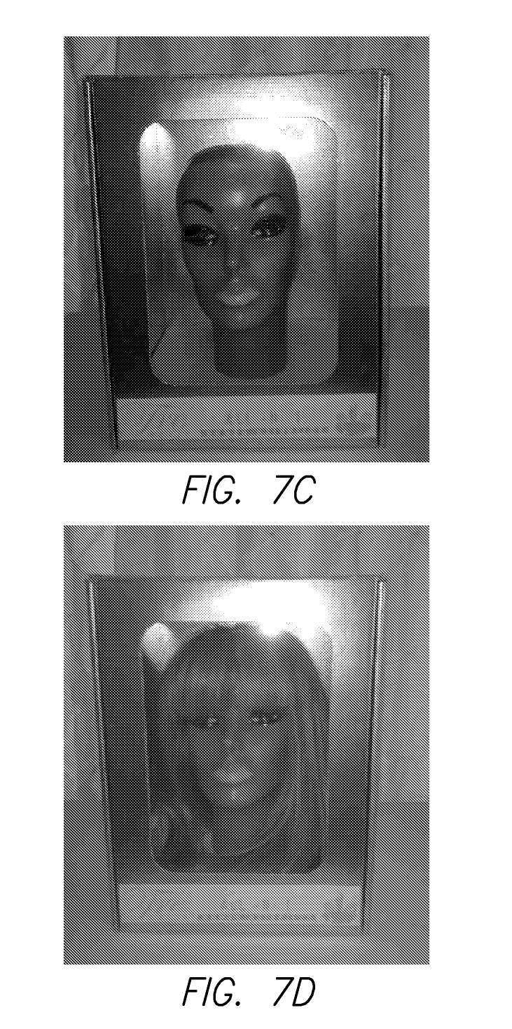

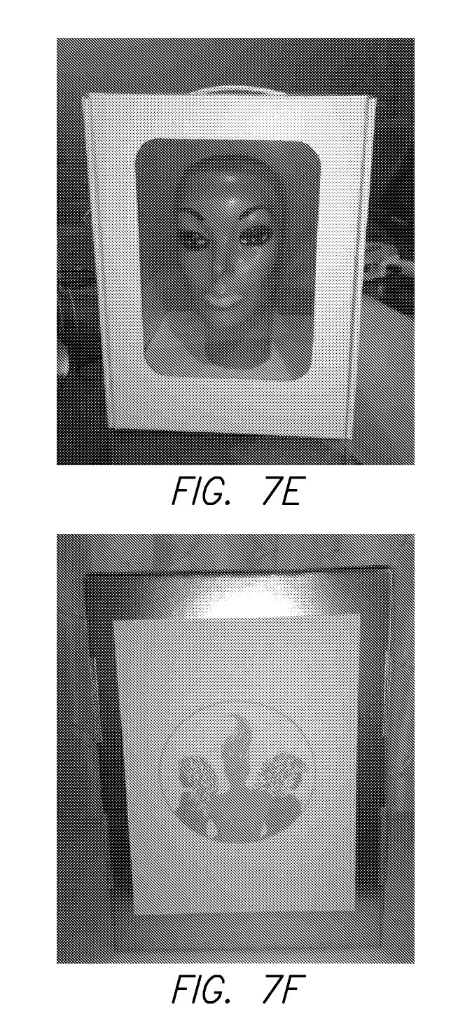

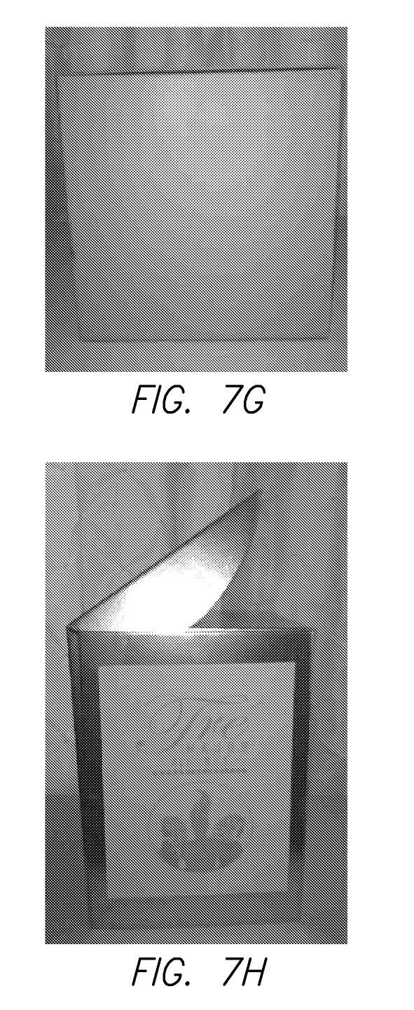

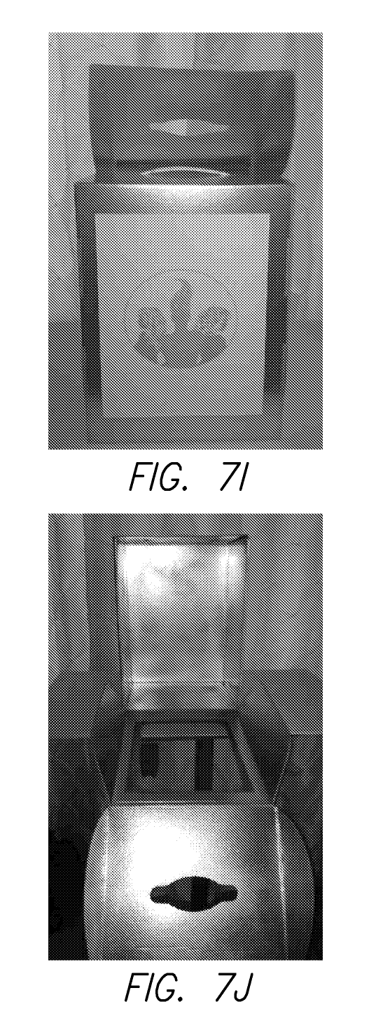

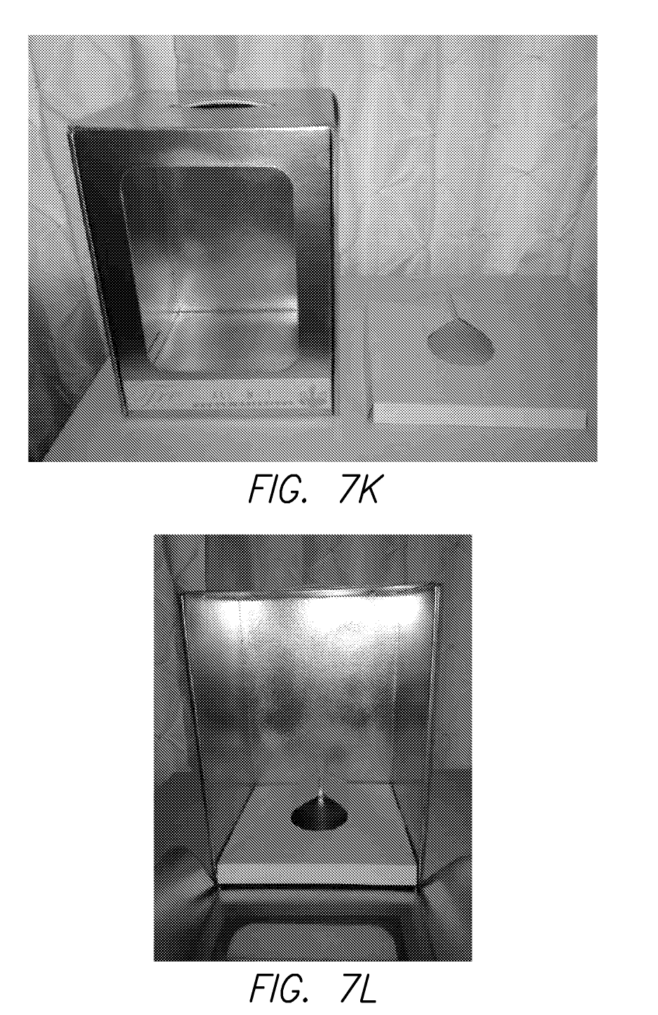

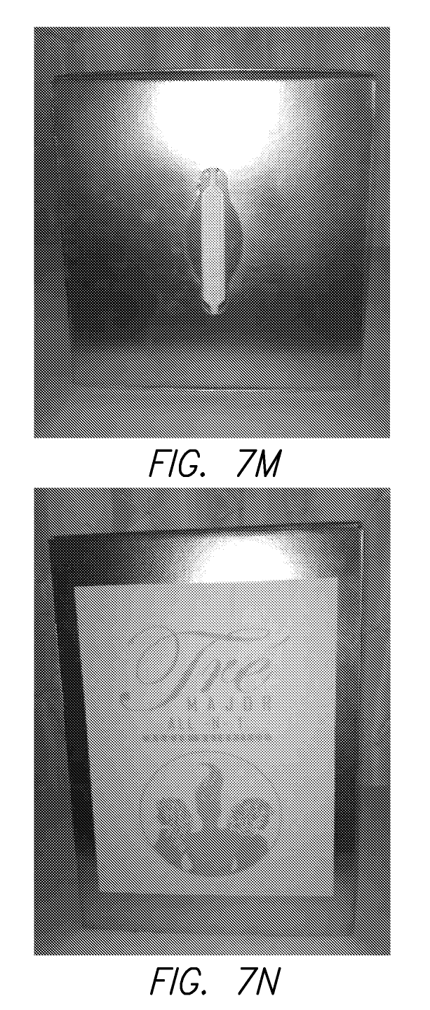

The box offers both functional and aesthetic advantages, as shown in FIGS. 7A-7N. The box features a transparent window in the front panel through which the wig, displayed on a supportive base, can be seen (FIGS. 7C-7E). Representative material for the window is 24 point poly(methyl methacrylate), also known as PLEXIGLAS® or similar plastic or acrylic transparent, light weight material, providing a sturdy material and a long life span for the box. The box can also serve as a keepsake. The box can be provided with the wig or offered as a separate product.

In a typical embodiment, the body of the box is made of a strong corrugated cardboard. One example of a high quality suitable cardboard material is E flute. The color of the box can be selected to enhance the appearance of the displayed wig, and/or to correlate with, thereby indicated, the quality of the displayed wig (e.g., bronze, silver, gold, platinum). The box surface is optionally coated with a material that further enhances the appearance. The box can optionally be silk screened, embossed and/or wrapped. In some embodiments, a logo is displayed on one or more sides of the box.

The box can further comprise an insert as shown in FIGS. 7K and 7L, to assist in securing the wig (and/or a model head on which the wig is displayed and supported) and to preserve the style by minimizing movement within the box. The optional insert comprises a sheet of rigid material (such as corrugated cardboard) having a substantially square shape and margins folded at a right angle along at least three of the four sides of the insert, forming a shape that fits snuggly inside the bottom of the box. The insert further forms a substantially annular opening disposed within the center of the insert and a slot, wherein the slot provides a contiguous opening between a rear side of the square and the annular opening. The slot and opening allow passage of the base of a model head into the center of the insert for secure positioning of the model inside the box. The entire insert is removable and separable from the box.

The box comprises a handle disposed on the top of the box (FIGS. 7I and 7K). The material used for the handle can be, for example, plastic, leather or metal, or other conventional material suitable for use as a handle. The box can serve as a wig display, a travel case, protection during transport, as well as a housing for wigs while stored, for example, at a user's home or salon to preserve and maintain the wig in optimal condition. The box is designed to allow the front to open up and out, and then down on its face (FIGS. 7A, 7B, 7H and 7J). This provides an appealing, eye catching piece as well us facilitating safe removal and replacement of the wig.

Although the above example describes a box wherein the window is disposed within the front panel, it is understood that the window could be disposed in any of the sides, and that the moveable panel that is contiguous with the moveable top panel need not be the front of the box, but could be a side or rear panel.

Although the present invention has been described in considerable detail with reference to certain preferred embodiments thereof, other embodiments are possible. Therefore, the spirit and scope of the appended claims should not be limited to the description of the preferred embodiments contained herein.

I claim:

1. A customizable wig comprising:
(a) a single base shell having an outer surface;
(b) a plurality of fastening means affixed to the outer surface of said base shell; and
(c) a plurality of hair segments comprising at least one crown segment, at least one mid-section segment, and at least one nape segment, wherein each of said hair segments comprises:
(i) a base material having lower and upper surfaces,
(ii) fastening means affixed to the lower surface of said base material, and
(iii) a plurality of hair strands affixed to and extending from the upper surface of said base material,
wherein each of said hair segments is removably attached to the outer surface of said base shell by said fastening means.

2. The customizable wig of claim 1, wherein said fastening means are selected from a group consisting of hook and loop fastening, snaps, hooks, and clips.

3. The customizable wig of claim 1, wherein said hair segments comprise at least two crown segments, at least two mid-section segments, and/or at least two nape segments.

4. The customizable wig of claim 1, wherein the crown segment comprises a front edge adapted to align with the forehead of a subject, and wherein the crown segment further comprises a sheer lace affixed to said front edge.

5. The customizable wig of claim 1, wherein said hair strands are selected from the group comprising human hairs and synthetic hairs.

6. The customizable wig of claim 1, further comprising enhancements selected from the group comprising hair wefts, feathers, and beads, said enhancements removably attached to the outer surface of said base shell by said fastening means.

7. A customizable wig comprising:
(a) a plurality of hair segments comprising at least one crown segment, at least one mid-section segment, and at least one nape segment, wherein each segment comprises a base material having lower and upper surfaces and perimeter edges and joining edges, and a plurality of hair strands affixed to and extending from the upper surface of said base material; and
(b) a plurality of fastening means affixed to said joining edges wherein said hair segments removably attach along said joining edges to form the shape of a human scalp.

8. The customizable wig of claim 7, wherein said fastening means are selected from the group consisting of hook and loop fastening, snaps, hooks, and clips.

9. The customizable wig of claim 8, wherein the plurality of said hair segments consist of a single crown segment, a single mid-section segment and a single nape segment, and wherein said fastening means are affixed to the upper surface of said joining edge of the mid-section segment and said fastening means are affixed to the lower surface of said joining edge of the crown and nape segments.

10. The customizable wig of claim 8, wherein the plurality of said hair segments consist of a single crown segment, a single mid-section segment and a single nape segment, and wherein said fastening means are affixed to the lower surface of said joining edge of the mid-section segment and said fastening means are affixed to the upper surface of said joining edge of the crown and nape segments.

11. The customizable wig of claim 7, wherein said hair segments comprise at least two crown segments, at least two mid-section segments, and/or at least two nape segments.

12. The customizable wig of claim 7, wherein said plurality of hair segments comprises at least one crown segment comprising an edge adapted to align with the forehead of a subject, and wherein said crown segment further comprises a sheer lace affixed to said front edge.

13. The customizable wig of claim 7, further comprising enhancements selected from the group comprising hair wefts, feathers, and beads removably attached to said base shell by said fastening means.

14. A customizable wig kit comprising:
(a) a single base shell having an outer surface; and
(b) a plurality of fastening means affixed to the outer surface of said base shell; and
(c) a plurality of hair segments comprising at least one crown segment, at least one mid-section segment, and at least one nape segment wherein each of said hair segments comprises:
(i) a base material having lower and upper surfaces,
(ii) fastening means affixed to the lower surface of said base material, and
(iii) a plurality of hair strands affixed to and extending from the upper surface of said base material, wherein each of said hair segments is removably attached to the outer surface of said base shell by said fastening means; and
(d) a set of instructions for assembling and arranging said hair segments.

15. A customizable wig kit, according to claim 12, wherein said instructions comprise an instructional video.
